(19) United States
(12) Patent Application Publication
(10) Pub. No.: US 2011/0187929 A1
(43) Pub. Date: Aug. 4, 2011

(54) COMMUNICATION APPARATUS

(75) Inventors: Nobuaki Suzuki, Tokyo (JP); Takashi Doi, Tokyo (JP)

(73) Assignee: KABUSHIKI KAISHA TOSHIBA, Tokyo (JP)

(21) Appl. No.: 12/965,730

(22) Filed: Dec. 10, 2010

(30) Foreign Application Priority Data
Jan. 29, 2010 (JP) 2010-019706

(51) Int. Cl. H04N 5/445; H04N 3/27

(52) U.S. Cl. 348/554; 348/564; 348/E03.049; 348/E05.099

(57) ABSTRACT

A communication apparatus includes: first and second input terminals configured to receive a video signal and transmit and receive a control signal; a first controller configured to output a first control command for setting a first video stream path through which a video signal that is output from a first source apparatus is to flow; a second controller configured to output a second control command for setting a second video stream path through which a video signal that is output from a second source apparatus is to flow; and a display module configured to display a display screen that is generated from first video and second video that are generated from video signals that are transmitted through the first and second video stream paths, respectively, and received by the first input terminal and the second input terminal.

### CROSS-REFERENCE TO THE RELATED APPLICATION(S)

The present application is based upon and claims priority from prior Japanese Patent Application No. 2010-019706, filed on Jan. 29, 2010, the entire contents of which are incorporated herein by reference.

### FIELD

Embodiments described herein generally relate to a communication apparatus.

### BACKGROUND

In recent years, the resolution of video has been increased and, for example, optical discs capable of recording HD (high-definition) images and apparatus capable of reproducing and displaying terrestrial digital broadcasts etc. such as optical disc players, set-top boxes, and personal computers have been widely spread. These kinds of apparatus usually have a function of outputting a high-resolution video signal to the outside and output a video signal via an HDMI (high-definition multimedia interface) cable.

In the HDMI standard, a source apparatus outputs a non-compressed video signal to a sync apparatus (a reproducing apparatus such as a digital TV receiver) via a TMDS line. The number of channels on which the sync apparatus can receive a video signal is only one (the number of video stream paths in an HDMI topology).

In the HDMI standard, in addition to output of a video signal, a control signal (CEC command) can be communicated bidirectionally via a CEC line. And various CEC commands are defined. For example, if a sync apparatus sends a “set stream path” command, the source apparatus for outputting a video signal to be received by the sync apparatus can be changed by switching the video signal path. An example of related technique is disclosed in JP-A-2008-109342.

However, in the HDMI standard and the like accommodate only one video stream and cannot accommodate, for example, a case of displaying pieces of video (of plural pictures) that are output from two apparatus by, for example, display of a child picture.

The document JP-A-2008-109342 discloses an embodiment of a TV receiver capable of displaying, as plural pictures (a main picture and a sub-picture), video of a broadcast signal received by a TV tuner of the TV receiver and video supplied from an external apparatus that is connected to the TV receiver by HDMI. However, in JP-A-2008-109342, no consideration is given to communicating plural video streams over an HDMI network.

### BRIEF DESCRIPTION OF THE DRAWINGS

A general configuration that implements the various features of the present invention will be described with reference to the drawings. The drawings and the associated descriptions are provided to illustrate embodiments of the invention and not to limit the scope of the invention.

FIG. 1 is a block diagram showing a configuration of a communication system according to an embodiment of the present invention.

FIG. 2 is a block diagram showing a configuration of a sync apparatus used in the embodiment of the invention.

FIG. 3 is a block diagram showing a configuration of a source apparatus used in the embodiment of the invention.

FIG. 4 is a block diagram showing a configuration of a relay apparatus used in the embodiment of the invention.

FIG. 5 is a flowchart of a process that is executed by the sync apparatus in the embodiment of the invention.

FIG. 6 is a flowchart of another process that is executed by the sync apparatus in the embodiment of the invention.

FIG. 7 is a flowchart of a process that is executed by a source apparatus in the embodiment of the invention.

FIG. 8 is a flowchart of a process that is executed by the relay apparatus in the embodiment of the invention.

### DETAILED DESCRIPTION

According to the embodiments described herein, there is provided a communication apparatus including: a first input terminal and a second input terminal configured to receive a video signal and transmit and receive a control signal; a first controller configured to output, from the first input terminal and the second input terminal, a first control command for setting a first video stream path through which a video signal that is output from a first source apparatus is to flow; a second controller configured to output, from the first input terminal and the second input terminal, a second control command for setting a second video stream path through which a video signal that is output from a second source apparatus is to flow; and a display module configured to display a display screen that is generated from first video and second video that are generated from video signals that are transmitted through the first and second video stream paths, respectively, and received by the first input terminal and the second input terminal.

Embodiments according to the present invention will be described in detail with reference to the accompanying drawings.

The scope of the claimed invention should not be limited to the examples illustrated in the drawings and those described in below.

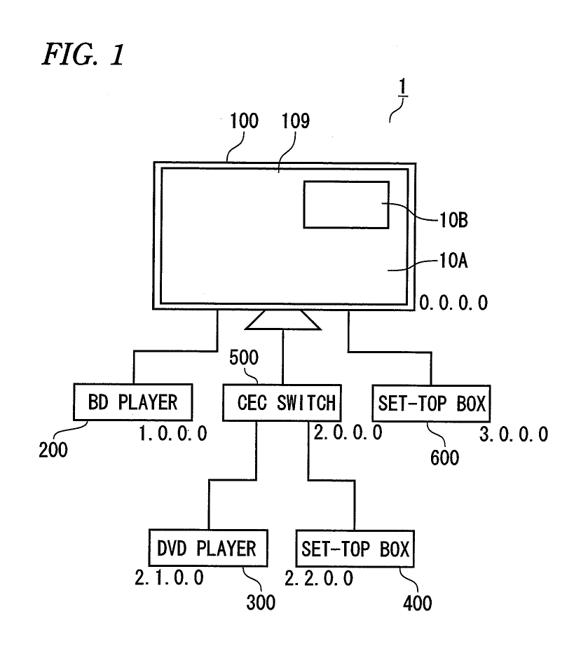

FIG. 1 is a schematic block diagram of an HDMI (high-definition multimedia interface) system according to the embodiment of the invention.

The HDMI system 1 includes a digital TV receiver 100 which is an electronic apparatus which receives terrestrial digital broadcast waves via an antenna (not shown), performs demodulation, and displays a resulting video signal or receives a video signal via an external input terminal and displays it, a BD (Blu-ray disc) player 200 which reproduces a content stored in an optical disc such as a BD, a DVD (digital versatile disc) player 300, set-top boxes 400 and 600 each of which receives terrestrial digital broadcast waves, performs demodulation, and outputs a resulting video signal, and a CEC switch 500 such as an AV (audio-visual) amplifier which switches the output destination of a video signal that is input from a CEC apparatus and performs video processing. As shown in FIG. 1, the above apparatus are connected to each other via HDMI cables.

In the HDMI system 1, the BD player 200, the DVD player 300, and the set-top boxes 400 and 600 are apparatus which output a video signal and will also be referred to as source apparatus. On the other hand, the digital TV receiver 100 is a display apparatus which receives a video signal and displays video on the basis of the received video signal and which will also be referred to as a sync apparatus. A flow of a video signal that is sent from a source apparatus to the digital TV receiver 100 (sync apparatus) will be referred to as a video stream.

Usually, in one HDMI system, it is assumed that only one video stream is communicated. In contrast, in the HDMI system 1 according to the embodiment, two video streams, that is, a video stream for a main picture and a video stream for a sub-picture, can be communicated. In the example of FIG. 1, video of a video stream for a main picture is displayed in the entire screen area 10A of a display panel 109 of the digital TV receiver 100 and video of a video stream for a sub-picture is displayed in a child screen area 10B of the display panel 109.

Although in the example of FIG. 1 a main picture and a sub-picture are displayed in picture-in-picture (PIP) form, the invention is not limited to such a case. For example, two pictures having the same size may be displayed side by side. Usually, only a sound corresponding to video being displayed as a main picture is output from speakers (not shown in FIG. 1) on the digital TV receiver 100.

Each HDMI cable has a TMDS (transmission minimized differential signaling) line for transmitting a video signal and an audio signal, a CEC (consumer electronics control) line for transmitting a control command (CEC command), a DDC (display data channel) line for, for example, transmitting EDID (extended display identification data), a +5 V power signal line (not shown) to be used when a source apparatus informs a sync apparatus that a connection has been made, and an HPD (hot plug detect) line (not shown) to be used when the sync apparatus informs the source apparatus that a connection has been made. Among the above lines, the TMDS line transmits a video signal in one direction, that is, from the source apparatus to the sync apparatus. On the other hand, the CEC line and the DDC line enable a bidirectional communication.

EDID data that is transmitted by the DDC line contains information indicating a displayable video format of the sync apparatus. This video format information includes display specifications such as a format and a resolution of video data and a sync frequency and audio specifications such as an audio data format, a sampling frequency Fs, and a bit length. The source apparatus can recognize video format information of the sync apparatus by reading EDID from an EDID memory of the sync apparatus.

The source apparatus exchanges data necessary for HDCP (high-bandwidth digital content protection) authentication with the sync apparatus via the DDC line. An example of data necessary for HDCP authentication is HDCP key information. In the example being described, it is assumed that HDCP key information is stored in a storage area of the sync apparatus. The term “authentication” means that the source apparatus confirms that the sync apparatus has the authority to receive a video signal. If authentication succeeds, the source apparatus sends video to the sync apparatus after encrypting it with a shared secret key.

EDID that the source apparatus reads from the sync apparatus via the DDC line contains a physical address to be assigned to an apparatus that is connected to the HDMI input terminal of the sync apparatus. The source apparatus acquires such a physical address. In this manner, an HDMI network (HDMI system 1) consisting of apparatus that are assigned respective physical addresses can be constructed. Usually, in an HDMI network, unique addresses are assigned to the respective apparatus. Physical addresses are pieces of information to be used for uniquely discriminating between positions of the individual apparatus in the network topology, and are used for, for example, a routing control for switching the video stream path through which to output a video signal to the sync apparatus (digital TV receiver 100).

The digital TV receiver 100 (sync apparatus, root device) has a physical address “0.0.0.0.” The digital TV receiver 100 (sync apparatus) generates a physical address to be assigned to an apparatus that is connected to an HDMI input terminal by incorporating a terminal number of the HDMI input terminal into its own physical address, and sets the generated physical address in EDID. EDID is prepared for each HDMI input terminal. In the example of FIG. 1, the digital TV receiver 100 has three HDMI input terminals and sets a physical address “1.0.0.0” in EDID corresponding to a first HDMI input terminal. The BD player 200 which is connected to the first HDMI input terminal can acquire “1.0.0.0” as its own physical address by reading this EDID via the DDC line.

Likewise, the digital TV receiver 100 sets a physical address “2.0.0.0” in EDID corresponding to a second HDMI input terminal and sets a physical address “3.0.0.0” in EDID corresponding to a third HDMI input terminal. The CEC switch 500 and the set-top box 600 which are connected to the second and third HDMI input terminals can acquire “2.0.0.0” and “3.0.0.0” as their own physical addresses by reading these EDIDs via the DDC lines, respectively.

Furthermore, the CEC switch 500 has two HDMI input terminals to which source apparatus are to be connected. The CEC switch 500 sets physical addresses “2.1.0.0” and “2.2.0.0” generated on the basis of its own physical address “2.0.0.0” in EDIDs corresponding to first and second HDMI input terminals, respectively. The DVD player 300 and the set-top box 400 which are connected to the first and second HDMI input terminals can acquire “2.1.0.0” and “2.2.0.0” as their own physical addresses by reading these EDIDs via the DDC lines, respectively.

In an HDMI network (in the example of FIG. 1, the HDMI system 1), a video stream path from a source apparatus to a sync apparatus (in the example of FIG. 1, the digital TV receiver 100) can be set by sending a CEC command for video stream path setting in which a physical address is designated. A “set stream path” command which is sent from a sync apparatus and an “active source” command which is sent from a source apparatus are existing CEC commands for setting a video stream path.

In the embodiment, it is assumed that a command for setting a video stream path is sent from the digital TV receiver 100 (sync apparatus). It is also assumed that a video stream path for a main picture is set by a “set stream path” command and a video stream path for a sub-picture is set by a “set sub-stream path” command. These CEC commands are broadcast from the digital TV receiver 100 to the individual apparatus in the HDMI network (HDMI system 1).

The configurations of the individual apparatus constituting the HDMI system 1 will be described with reference to FIGS. 1-3.

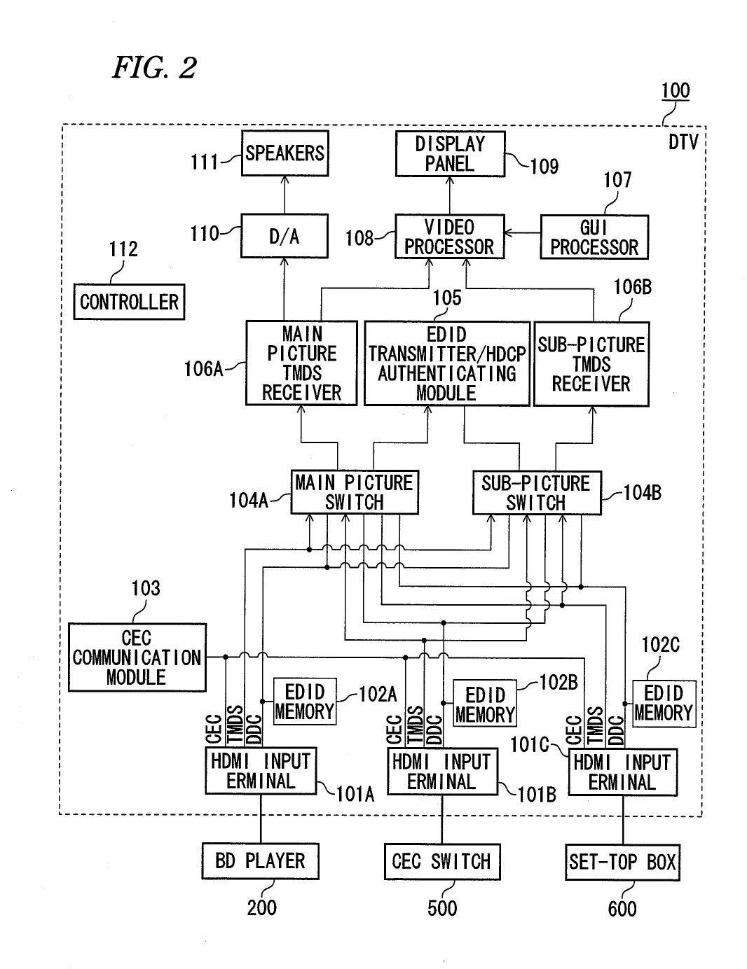

FIG. 2 is a block diagram showing the configuration of the digital TV receiver 100 which is the sync apparatus. The digital TV receiver 100 has plural (three) HDMI input terminals 101A, 101B, and 101C, and the a main picture switch 104A and a sub-picture switch 104B select an HDMI input terminal for a main picture and an HDMI input terminal for a sub-picture, respectively. The sub-picture switch 104B need not operate all the time; it is required to operate at least while a video stream path is set for a sub-picture, that is, from sending of a “set sub-stream path” command to sending of a “clear sub-stream path” command. The same is true of a sub-picture TMDS receiver 106B (described later).

Each of the HDMI input terminals 101A, 101B, and 101C mainly has pins of a TMDS line, a +5 V power line (not shown), a hot plus detection (HPD) line (not shown), a DDC line, and a CEC line.

The CEC lines of the HDMI input terminals 101A, 101B, and 101C are connected in common to a CEC communication module 103. Various CEC commands to be communicated in the HDMI system 1 are sent or received by the CEC communication module 103. In particular, such commands as a “set stream path” command for setting a video stream path for a main picture, a “set sub-stream path” command for setting a video stream path for a sub-picture, a “clear sub-stream path” command for disconnecting a video stream path for a sub-picture are broadcast from the HDMI input terminals 101A, 101B, and 101C to the individual apparatus constituting the HDMI system 1 under the control of the CEC communication module 103.

The physical address of a source apparatus as a video output source is specified in each of a “set stream path” command for setting a video stream path for a main picture and a “set sub-stream path” command for setting a video stream path for a sub-picture. Each apparatus in the network can recognize, by referring to the above physical address, whether or not it is designated as a source apparatus (output source) of a video stream or it is made a relay apparatus (also called a repeater apparatus) of a video stream (i.e., whether or not its upstream apparatus is designated as a source apparatus).

The TMDS line and the DDC line of each of the HDMI input terminals 101A, 101B, and 101C are connected to the input sides of the main picture switch 104A and the sub-picture switch 104B each of which has three inputs and one output. EDID memories 102A, 102B, and 102C, which are nonvolatile memories, are connected to the respective DDC lines. The EDID memories 102A, 102B, and 102C are only required to be nonvolatile; they are not limited to a flash memory and may be a hard disk drive or a RAM to which a backup power source is connected.

The EDID memories 102A, 102B, and 102C are stored with the physical addresses assigned to the source apparatus that are connected to the corresponding HDMI input terminals 101A, 101B, and 101C, respectively. For example, in the example of FIG. 1, the EDID memories 102A, 102B, and 102C which are connected to the HDMI input terminals 101A, 101B, and 101C are stored with “1.0.0.0,” “2.0.0.0,” and “3.0.0.0,” respectively.

The TMDS lines of HDMI input terminals selected by the main picture switch 104A and the sub-picture switch 104B are connected to a main picture TMDS receiver 106A and a sub-picture TMDS receiver 106B, respectively. And the DDC lines of the HDMI input terminals selected by the main picture switch 104A and the sub-picture switch 104B are connected to an EDID transmitter/HDCP authenticating module 105.

Video signals that are output from the main picture TMDS receiver 106A and the sub-picture TMDS receiver 106B are supplied to a video processor 108, and video is displayed on the display panel 109 under the control of the video processor 108. If a setting to the effect that both of a main picture and a sub-picture should be output is made, the video processor 108 performs processing of combining a main picture and a sub-picture and resulting video is displayed on the display panel 109.

When displaying a menu screen, an output destination switching picture, or the like to the user, a GUI processor 107 generates an image data for the menu screen and outputs it to the video processor 108, whereby the menu screen or the like is displayed on the display panel 109.

In the embodiment, only a sound of a video signal (video stream) of a main picture is output. An audio signal that is output from the main picture TMDS receiver 106 is supplied to the speakers 111 via a D/A converter 110.

A controller 112 controls the entire digital TV receiver 100.

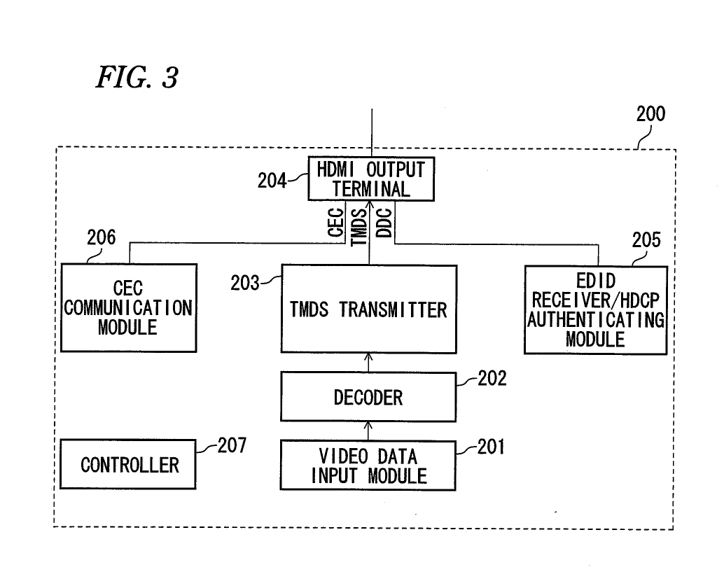

Next, the configuration of a source apparatus will be described. Although the BD player 200 will be described below with reference to FIG. 3, the DVD player 300 and the set-top boxes 400 and 600 have the same configuration except for the video input method.

The BD player 200 has an HDMI output terminal 204. Like the HDMI input terminals 101A, 101B, and 101C of the digital TV receiver 100, the HDMI output terminal 204 mainly has pins of a TMDS line, a +5 V power line (not shown), a hot plus detection (HPD) line (not shown), a DDC line, and a CEC line.

The CEC line of the HDMI output terminal 204 is connected to a CEC communication module 206. Various CEC commands that are communicated in the HDMI system 1 are sent or received by the CEC communication module 206. In particular, if a “set stream path” command for setting a video stream path for a main picture or a “set sub-picture path” command for setting a video stream for path a sub-picture is received and the physical address contained in the received command coincides with the physical address of the BD player 200, which means that the BD player 200 has been designated as a source apparatus of the video stream path concerned, a controller 207 performs a control to start output of a video signal. If a “clear sub-stream path” command is received in a state that the BD apparatus 200 is outputting a video signal as a source apparatus of a video stream path for a sub-picture, the controller 207 performs a control to stop the output of the video signal.

The DDC line of the HDMI output terminal 204 is connected to an EDID receiver/HDCP authenticating module 205. The EDID receiver/HDCP authenticating module 205 can acquire the video format information (described above) of the digital TV receiver 100 and the physical address (in the example of FIG. 1, “1.0.0.0”) assigned to the BD player 200 by reading the EDID from the EDID memory 102A of the HDMI input terminal 101A of the digital TV receiver 100 which is a one-layer-higher sync apparatus. The EDID receiver/HDCP authenticating module 205 also performs authentication processing for the sync apparatus.

A signal in which a video signal and an audio signal are superimposed on each other and which is output from a TMDS transmitter 203 is supplied to the TMDS line of the HDMI output terminal 204. The video signal that is output from the TMDS transmitter 203 is a non-compressed video signal obtained by decoding, with a decoder 202, video data that is read by a video data input module 201. The video data input module 201 reads video data that is reproduced from an optical medium such as a Blu-ray disc, broadcast program data obtained by demodulating a broadcast signal received by a TV tuner (not shown), or like data.

The controller 207 supervises various components provided in the BD player 200 according to a user operation that is input through a remote controller (not shown), an operation panel (not shown), or the like, a CEC command received by the CEC communication module 206, or a like instruction.

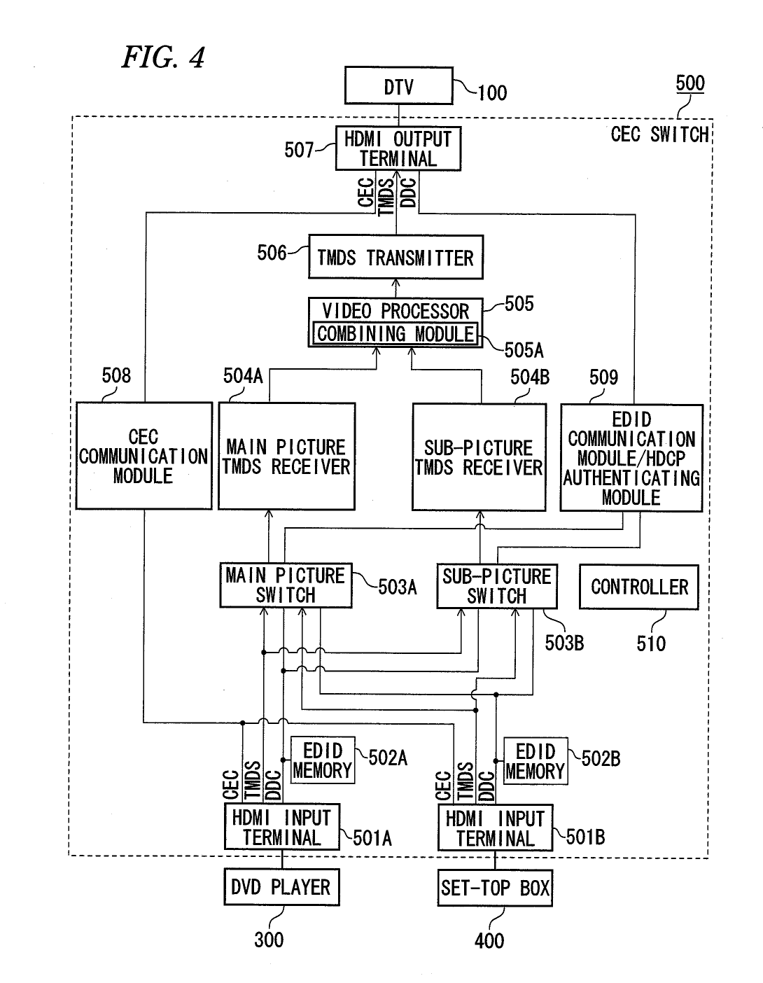

Next, the configuration of the CEC switch 500 which functions as a relay apparatus (repeater apparatus) will be described with reference to FIG. 4. FIG. 4 is a block diagram showing the configuration of the CEC switch 500. The CEC switch 500, which is an HDMI apparatus having two inputs and one output, can output, from an HDMI output terminal 507, a video signal that is input via an HDMI input terminal 501A or 501B. Like the above-described terminals, each of the HDMI input terminal 501A and 501B and the HDMI output terminal 507 mainly has pins of a TMDS line, a +5 V power line (not shown), a hot plus detection (HPD) line (not shown), a DDC line, and a CEC line.

The CEC lines of the HDMI input terminal 501A and 501B and the HDMI output terminal 507 are connected to a CEC communication module 508. Various CEC commands that are communicated in the HDMI system 1 are sent or received by the CEC communication module 508. Example CEC commands that are sent or received by the CEC communication module 508 are a “set stream path” command for setting a video stream path for a main picture, a “set sub-picture path” command for setting a video stream path for a sub-picture, and a “clear sub-stream path” command for disconnecting a video stream path for a sub-picture. In particular, a controller 510 can recognize whether or not an apparatus (in the example of FIG. 1, the DVD player 300 or the set-top box 400) located upstream of the CEC switch 500 is designated as a source apparatus for outputting a video stream by referring to the source apparatus physical address that is set in a “set stream path” command or a “set sub-picture path” command. If an apparatus located upstream of the CEC switch 500 is designated as a source apparatus, switching sections 503A and 503B make switching to the HDMI input terminal 501A or 501B to which the source apparatus is connected.

Even if the DVD player 300 and the set-top box 400 which are connected to the HDMI input terminal 501A and 501B of the CEC switch 500 are designated as a source apparatus of a video stream for a main picture and a source apparatus of a video stream for a sub-picture, respectively, video streams on two channels cannot be output from the HDMI output terminal 507. Therefore, the controller 510 performs a control so that a video signal is generated by a combining module 505A of a video processor 505 (described later) by combining a main picture and a sub-picture and output from the HDMI output terminal 507.

The TMDS line and the DDC line of each of the HDMI input terminals 501A and 501B are connected to the input sides of a main picture switch 503A and a sub-picture switch 503B each of which has two inputs and one output. EDID memories 502A and 502B, which are nonvolatile memories, are connected to the respective DDC lines. The EDID memories 502A and 502B are stored with the physical addresses assigned to the source apparatus that are connected to the corresponding HDMI input terminals 501A and 501B, respectively. For example, in the example of FIG. 1, the EDID memories 502A and 502B which are connected to the HDMI input terminals 501A and 501B are stored with “2.1.0.0,” and “2.2.0.0,” respectively. These physical addresses to be stored in the EDID memories 502A and 502B are set by an EDID communication module/HDCP authenticating module 509 on the basis of the physical address “2.0.0.0” of the CEC switch 500 which is acquired from the digital TV receiver 100.

The TMDS line of an HDMI input terminal 501A or 501B selected by the main picture switch 503A or the sub-picture switch 503B is connected to a main picture TMDS receiver 504A or a sub-picture TMDS receiver 504B. The DDC line of the selected HDMI input terminal 501A or 501B is connected to the EDID communication module/HDCP authenticating module 509.

The EDID communication module/HDCP authenticating module 509 is also connected to the DDC line of the HDMI output terminal 507. The EDID communication module/HDCP authenticating module 509 can acquire the video format information (described above) of the digital TV receiver 100 and the physical address (in the example of FIG. 1, “2.0.0.0”) assigned to the CEC switch 500 by reading EDID from the digital TV receiver 100 which is a one-layer-higher sync apparatus. The EDID communication module/HDCP authenticating module 509 also performs authentication processing for the sync apparatus.

Furthermore, as described above, the EDID communication module/HDCP authenticating module 509 sets the physical addresses (in the example of FIG. 1, “2.1.0.0” and “2.2.0.0”) to be stored in the EDID memories 502A and 502B of the HDMI input terminals 501A and 501B, respectively, on the basis of the acquired physical address “2.0.0.0” of the CEC switch 500.

A video signal that is output from the main picture TMDS receiver 504A or the sub-picture TMDS receiver 504B is supplied to the video processor 505 and then supplied to the TMDS line of the HDMI output terminal 507 under the control of the video processor 505. Where a setting to the effect that both of a main picture video stream and a sub-picture video stream should be output is made (i.e., a “set stream path” command and a “set sub-stream path” command were received in which the two source apparatus located upstream of the HDMI input terminals 501A and 501B were designated as source apparatus), the video processor 505 outputs, to the HDMI output terminal 507, a video signal (e.g., a video signal of combined video in picture-in-picture form (see FIG. 1)) obtained by combining the two video signals together. In this case, a TMDS transmitter 506 outputs only an audio signal corresponding to the main picture video stream via the TMDS line.

The controller 510 supervises various components provided in the CEC switch 500 according to, for example, a CEC command that is received by the CEC communication module 508.

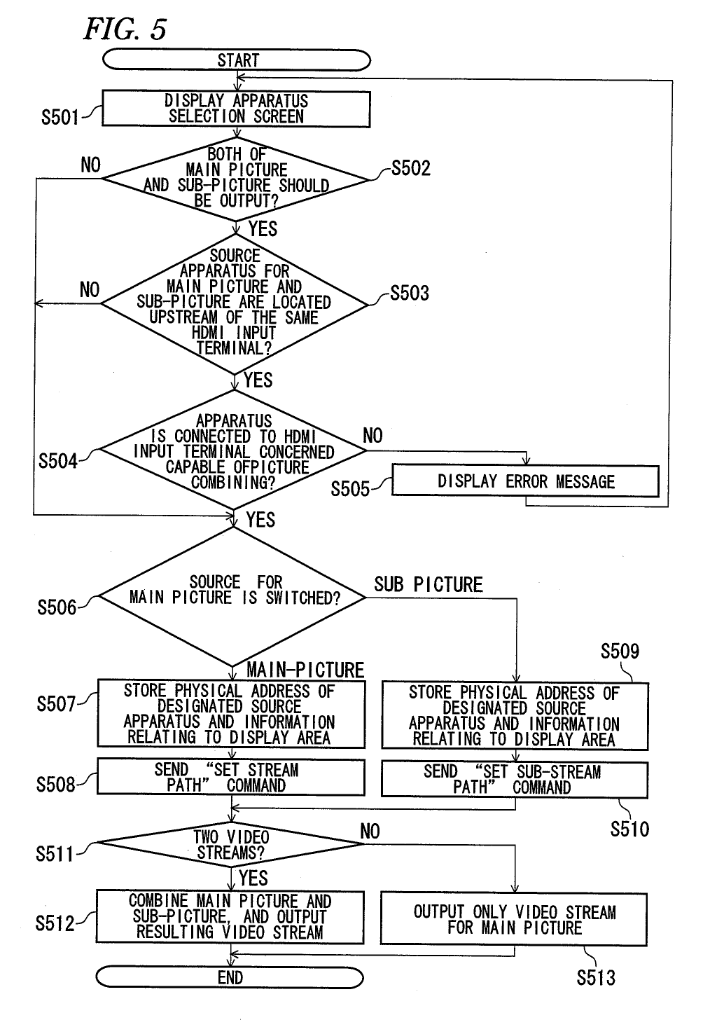

How each of apparatus constituting the HDMI system 1 operate will be described below with reference to FIGS. 5-8.

First, a process that relates to setting of a video stream path and is executed by the sync apparatus will be described. FIG. 5 is a flowchart of a process that relates to setting of a video stream path and is executed by the digital TV receiver 100.

If the user wants to switch the source apparatus for a main picture or a sub-picture, he or she causes display of an apparatus selection screen. At step S501, the GUI processor 107 outputs an apparatus selection screen through which to switch the video stream path for a main picture or a sub-picture and causes the user to set a new source apparatus.

If a setting to the effect that only a main picture or a sub-picture should be output is made (S502: no), the process proceeds to step S506 (i.e., moves to video stream path setting steps). If a setting to the effect that both of a main picture and a sub-picture should be output is made (S502: yes), at step S503 the controller 112 refers to the physical addresses of apparatus that are selected as source apparatus of video streams for a main picture and a sub-picture and determines whether those apparatus are located upstream of the same HDMI input terminal or located upstream of different HDMI input terminals. If two apparatus that are located upstream of different HDMI input terminals are designated as source apparatus for a main picture and a sub-picture (e.g., the BD player 200 is designated as a source apparatus for a main picture and the set-top box 400 is designated as a source apparatus for a sub-picture) (S503: no), the process proceeds to step S506.

If two designated apparatus are located upstream of the same HDMI input terminal (e.g., in the example of FIG. 1, the DVD player 300 is designated as a source apparatus for a main picture and the set-top box 400 is designated as a source apparatus for a sub-picture) (S503: yes), it is determined at step S504 whether the apparatus connected to the HDMI input terminal concerned (in the example of FIG. 1, the CEC switch 500) is capable of picture combining processing. For example, whether that apparatus is capable of picture combining processing may be determined on the basis of its ID or the like or by making an inquiry using a newly defined CEC command for checking whether an apparatus is capable of picture combining processing.

If the apparatus (in the example of FIG. 1, the CEC switch 500) to which the two designated source apparatus are connected is not capable of picture combining processing (S504: no), it is impossible to transmit video streams on two channels for a main picture and a sub-picture using the single HDMI cable. Therefore, at step S505, the GUI processor 107 notifies the user of that fact by displaying an error message. If the apparatus (in the example of FIG. 1, the CEC switch 500) to which the two designated source apparatus are connected is capable of picture combining processing (S504: yes), the process proceeds to step S506. In the embodiment, it is assumed that the CEC switch 500 is capable of picture combining processing, unless otherwise specified.

At step S506, the controller 112 determines whether at step S501 the user commanded switching of the source apparatus for a main picture or a sub-picture. In either case, at step S507 or S509, the controller 112 stores the physical address of the designated source apparatus and a size and a display position of a picture to be displayed. If the user commanded switching of the source apparatus for a main picture, at step S508 a “set stream path” command is broadcast from the HDMI input terminals 101A, 101B, and 101C. If the user commanded switching of the source apparatus for a sub-picture, at step S510 a “set sub-stream path” command is broadcast from the HDMI input terminals 101A, 101B, and 101C. As described above, each of the “set stream path” command and the “set sub-stream path” command contains the physical address of the source apparatus of the video stream path to be set by the command.

When a preparation for a start of reception of a video stream has completed, at step S511 the controller 112 determines whether two video streams (a video stream for a main picture and a video stream for a sub-picture) should be received or one video stream (only a video stream for a main picture or a video stream obtained by combining a main picture and a sub-picture) should be received. If two video streams should be received (S511: yes), at step S512 the controller 112 performs a control so that the video processor 108 performs processing of combining a main picture and a sub-picture. If one video stream should be received (S511: no), at step S513 the controller 112 causes no combining processing and performs a control so that the video processor 108 outputs only a video stream for a main picture. When one video stream should be received, neither the sub-picture switch 104B nor the sub-picture TMDS receiver 106B needs to function.

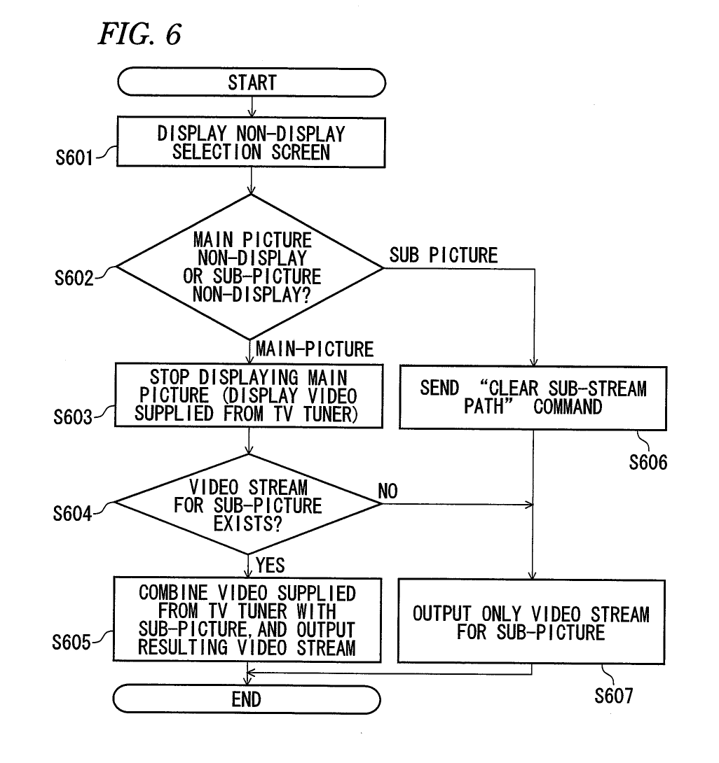

Next, a process that is executed by the sync apparatus in making a non-display setting will be described with reference to FIG. 6. FIG. 6 is a flowchart of a process that is executed by the digital TV receiver 100 in making a non-display setting.

First, at step S601, the controller 112 receives a non-display setting instruction from the user by causing the GUI processor 107 to output a non-display selection screen or receiving that instruction from the remote controller.

At step S602, the controller 112 determines whether the given instruction is an instruction not to display a main picture or a sub-picture. If the given instruction is an instruction not to display a main picture (S602: main picture), at step S603 the TMDS receiver 106A stops outputting a video signal to the video processor 108 and the video processor 108 causes the display panel 109 to display, for example, video of a video signal supplied from the TV tuner (not shown).

Where the display of video of a video stream for a main picture should be stopped, it is determined at step S604 whether there also exists a video stream for a sub-picture. If there also exists a video stream for a sub-picture (S604: yes), at step S605 video of a video signal supplied from the TV tuner, for example, is combined with video of the video signal that is output from the sub-picture TMDS receiver 106B and resulting video is displayed on the display panel 109.

If an instruction not to display a video stream for a sub-picture was given by the user (S602: sub-picture), at step S606 a “clear sub-stream path” command for disconnecting a video stream path for a sub-picture is broadcast from the HDMI input terminals 101A, 101B, and 101C.

Since the output of the video stream for a sub-picture is stopped as a result of the sending of the above command, at step S607 the video processor 108 outputs only a video stream for a main picture.

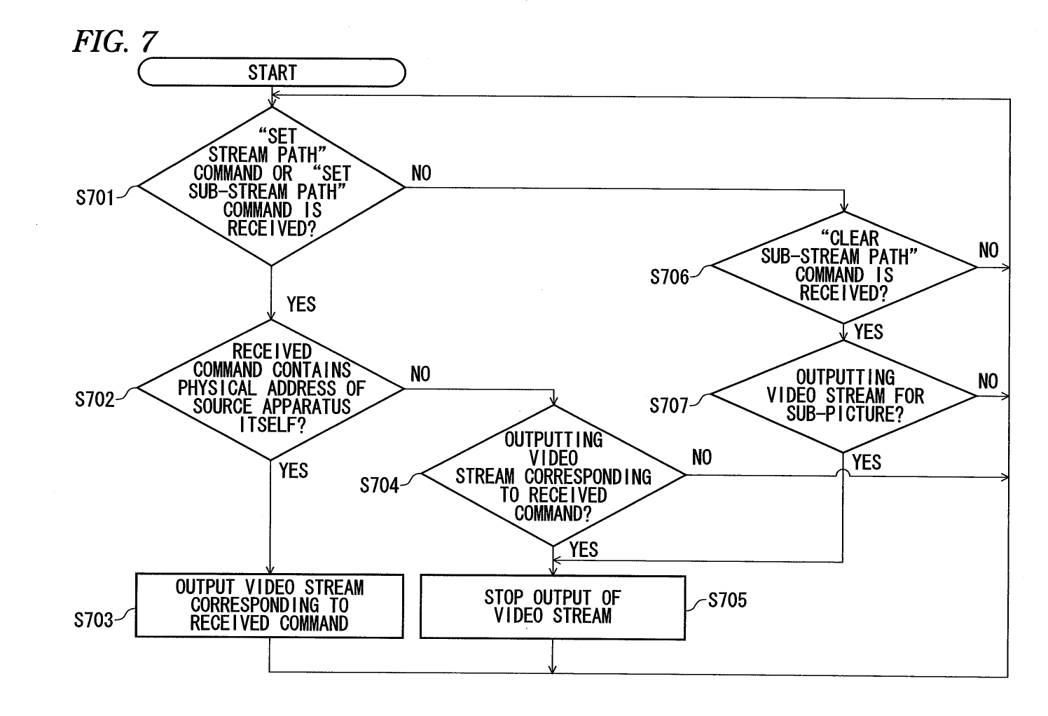

Next, a process that is executed by a source apparatus (assumed to be the BD player 200) will be described with reference to FIG. 7. The same process is executed by the other source apparatus.

First, at step S701, the BD player 200 determines whether a “set stream path” command or a “set sub-stream path” command which is a CEC command for setting a video stream path has been received by the HDMI output terminal 204. If a video stream path setting command has been received (S701: yes), it is determined at step S702 whether or not the received command contains the physical address of the BD player 200. If the received command contains the physical address of the BD player 200 (S702: yes), at step S703 the TMDS transmitter 203 starts outputting, as a source apparatus, a video stream for a main picture or a sub-picture via the HDMI output terminal 204.

If the received video stream path setting command does not contain the physical address of the BD player 200 (S702: no), it is determined at step S704 whether or not the BD player 200 is outputting a video stream corresponding to the received command (a video stream for a main picture in the case of a “set stream path” command and a video stream for a sub-picture in the case of a “set sub-stream path” command). If the BD player 200 is outputting such a video stream (S704: yes), at step S705 the TMDS transmitter 203 stops outputting the video stream because another apparatus should be designated as a source apparatus for outputting a video stream and the BD player 200 need not continue the output.

On the other hand, if a “clear sub-stream path” command which is a CEC command for disconnecting a video stream path for a sub-picture has been received (S706: yes), it is determined at step S707 whether or not the BD player 200 is outputting a video stream for a sub-picture. If the BD player 200 is outputting a video stream for a sub-picture, at step S705 the output is stopped.

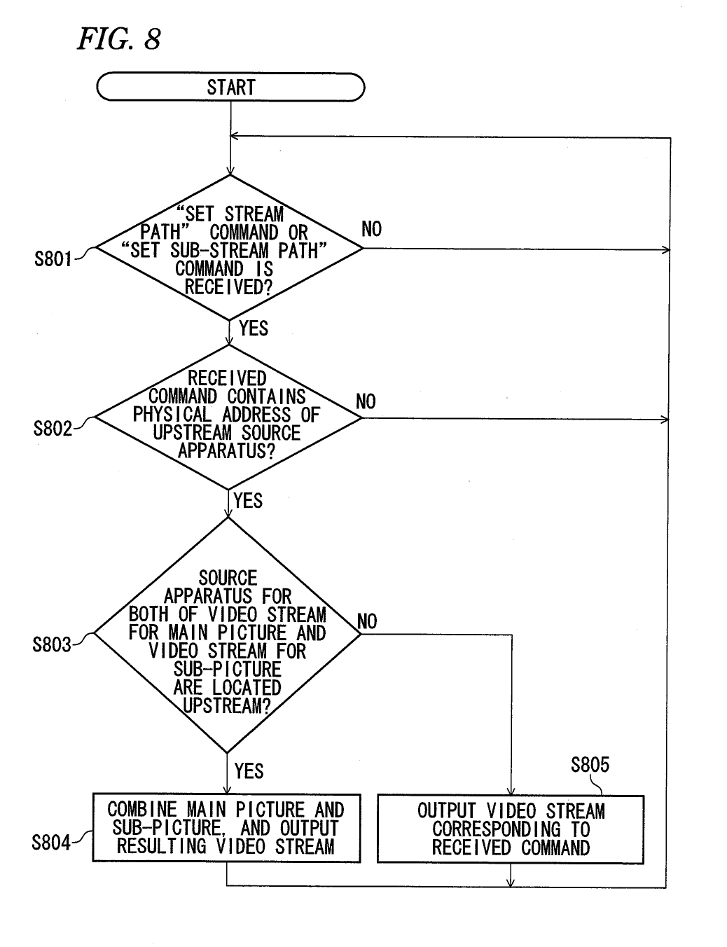

Next, a process that is executed by the relay apparatus having the picture combining function will be described with reference to FIG. 8. FIG. 8 is a flowchart of a process that is executed by the CEC switch 500.

At step S801, the controller 510 determines whether or not a “set stream path” command or a “set sub-stream path” command which is a CEC command for setting a video stream path has been received by the HDMI output terminal 507. If a video stream path setting command has been received (S801: yes), it is determined at step S802 whether or not the received command contains the physical address of an apparatus (in the example of FIG. 1, the DVD player 300 or the set-top box 400) located upstream of the CEC switch 500.

If the received command contains the physical address of an apparatus located upstream of the CEC switch 500 (S802: yes), it is determined at step S803 whether or not source apparatus for both of a video stream for a main picture and a video stream for a sub-picture are located upstream of the CEC switch 500, that is, whether or not video streams should be received by the two HDMI input terminals 501A and 501B.

If source apparatus for both of a video stream for a main picture and a video stream for a sub-picture are located upstream of the CEC switch 500 (S803: yes), a video stream obtained by combining video streams that are input via the HDMI input terminals 501A and 501B with the combining module 505A of the video processor 505 is output from the HDMI output terminal 507.

If a source apparatus of only one of a video stream for a main picture and a video stream for a sub-picture is located upstream of the CEC switch 500 (S803: no), a received video stream is not subjected combining processing etc. and output from the HDMI output terminal 507.

As described above, in the embodiment, a command for setting a video stream path for a sub-picture is defined in addition to a command for setting a video stream path for a main picture. As a result, the digital TV receiver 100 (sync apparatus) can display pieces of video of video signals that are output from two source apparatus.

A command for disconnecting a video stream path is also defined. As a result, a source apparatus can recognize timing when output of a video signal becomes unnecessary, which can in turn prevent an event that output of an unnecessary video stream continues. Preventing execution of such unnecessary processing can, for example, lower the power consumption.

Furthermore, according to the embodiment, since the CEC switch 500 (relay apparatus, repeater apparatus) can perform picture combining processing, plural pictures can be displayed even in the case where plural source apparatus are connected to the CEC switch 500.

Although in the embodiment only a CEC command for disconnecting a video stream path for a sub-picture is prepared, the invention is not limited to such a case. A CEC command for disconnecting a video stream path for a main picture may also be defined.

Although the embodiments according to the present invention have been described above, the present invention is not limited to the above-mentioned embodiments but can be variously modified. Components disclosed in the aforementioned embodiments may be combined suitably to form various modifications. For example, some of all components disclosed in the embodiments may be removed or may be appropriately combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A communication apparatus comprising:
a first input terminal and a second input terminal configured to receive a video signal and to transmit and receive a control signal;
a first controller configured to output, from the first input terminal and the second input terminal, a first control command for setting a first video stream path through which a first video signal that is output from a first source apparatus is to flow;
a second controller configured to output, from the first input terminal and the second input terminal, a second control command for setting a second video stream path through which a second video signal that is output from a second source apparatus is to flow; and
a display module configured to display a display screen that is generated from a first video and a second video that are generated from the first and second video signals that are transmitted through the first and second video stream paths, respectively, and received by the first input terminal and the second input terminal.

2. The apparatus of claims 1,
wherein the second controller is configured to output, from the first input terminal and the second input terminal, a third control command for disconnecting the second video stream path.

3. The apparatus of claim 1 further comprising:
an audio output module configured to output first audio contained in a first audio signal that is superimposed on the first video signal that flows through the first video stream path,
wherein the audio output module is configured to stop outputting second audio contained in a second audio signal that is superimposed on the second video signal that flows through the second video stream path while outputting the first audio contained in the first audio signal that is superimposed on the first video signal that flows through the first video stream path.

4. The apparatus of claim 1 further comprising:
a display controller configured to output a setting screen for selecting the first source apparatus and the second source apparatus, and for outputting an error message when both the first source apparatus and the second source apparatus are located upstream of the first input terminal or the second input terminal.

5. A communication apparatus comprising:
an output terminal configured to transmit a video signal and to transmit and receive a control signal; and
a video output module configured to output a video signal via the output terminal when a first control command for setting a first video stream path or a second control command for setting a second video stream path is received.

6. The apparatus of claim 5,
wherein the video output module is configured to stop outputting the video signal being output from the output terminal through the first video stream path when the first control command that designates another source apparatus is received, and
wherein the video output module is configured to stop outputting the video signal being output from the output terminal through the second video stream path when the second control command that designates another source apparatus, or a third control command for disconnecting the second video stream path, is received.

7. A communication apparatus comprising:
a first input terminal and a second input terminal configured to receive first and second video signals, respectively, and to transmit and receive first and second control signals, respectively, the first input terminal and the second input terminal being connected to first and second source apparatuses, respectively;
an output terminal configured to output the first and second video signals, and to transmit and receive the first and second control signal; and
a video processor configured to output, via the output terminal, a combined video that is generated from a first video of the first video signal that is input from the first input terminal and a second video of the second video signal that is input from the second input terminal.

8. The communication apparatus of claim 7,
wherein the video processor is configured to output the combined video via the output terminal when a first control command and a second control command is received via the output terminal,
wherein the first control command is for setting a first video stream path through which the first video signal that is output from the first source apparatus located upstream of the first input terminal is to flow, and
the second control command is for setting a second video stream path through which the second video signal that is output from the second source apparatus located upstream of the second input terminal is to flow.
